(19) United States
(12) Patent Application Publication
(10) Pub. No.: US 2017/0264910 A1
(43) Pub. Date: Sep. 14, 2017

(54) VIDEO STREAM DECODING METHOD AND VIDEO STREAM DECODING SYSTEM

(71) Applicant: MStar Semiconductor, Inc., Hsinchu Hsien (TW)

(72) Inventors: Yi-Chin Huang, Zhubei City (TW); Yi-Shin Tung, Zhubei City (TW)

(21) Appl. No.: 15/294,981

(22) Filed: Oct. 17, 2016

(30) Foreign Application Priority Data
Mar. 10, 2016 (TW) 105107360

(51) Int. Cl. H04N 19/50; H04N 19/105; H04N 19/15

(52) U.S. Cl. CPC H04N 19/50; H04N 19/15; H04N 19/105; H04N 19/172

(57) ABSTRACT

A video stream decoding system includes a video decoder, a frame encoder and a buffer. The frame encoder includes a prediction unit and a compressor. The prediction unit predicts an image data group in a prediction block of a frame to generate a predicted image data group. The prediction image data group includes a first sub predicted image data group and a second sub predicted image data group. The compressor compresses the first sub predicted image data group in a unit of the first sub predicted image data group to generate a first compressed image data group, and compresses the second sub predicted image data group in a unit of the second sub predicted image data group to generate a second compressed data image group.

This application claims the benefit of Taiwan application Serial No. 105107360, filed Mar. 10, 2016, the subject matter of which is incorporated herein by reference.

### BACKGROUND OF THE INVENTION

Field of the Invention

The invention relates in general to a video stream processing method and a video stream processing system, and more particularly to a video stream decoding method and a video stream decoding system.

Description of the Related Art

FIG. 1 shows a schematic diagram of a conventional video stream decoding system 100. The video stream decoding system 100 is, for example, disposed in a television or a computer. The video stream decoding system 100 includes a video decoder 110, a frame encoder 120, a buffer 130 and a frame decoder 140. The frame encoder 120 includes a compressor 122. The frame decoder 140 includes a decompressor 142. The video decoder 110 receives a video stream that includes multiple coded frames, and decodes the coded frames to generate a frame. The frame includes multiple coding blocks, each being a smallest unit for independent coding or decoding. The frame encoder encodes the frame by a unit of one coding block. The compressor 122 in the frame encoder 120 compresses an image data group in a coding block of the frame to generate a compressed image data group, and outputs the compressed image data group to the buffer 130 via a bus B1. The compressed image data group is buffered in the buffer 130. When the video decoder 110 needs to refer to the compressed image data group during a decoding process, the buffer 130 outputs the compressed image data to the frame decoder 140 via the bus B1. The decompressor 142 of the frame decoder 140 decompresses the compressed image data group to generate the image data group, and outputs the image data group to the video decoder 110 for the video decoder 110 to refer to in the decoding process.

### SUMMARY OF THE INVENTION

The invention is directed to a video stream decoding method and a video decoding system that enhance compression efficiency by a partitioned compression approach to reduce bus bandwidth usage.

According to an aspect of the present invention, a video stream decoding system is provided. The video stream decoding system includes a video decoder, a frame encoder and a buffer. The video decoder receives a video stream, and decodes a coded frame in the video stream to generate a frame. The frame includes a plurality of prediction blocks. The frame encoder includes a prediction unit and a compressor. The prediction unit predicts an image data group in a prediction block of the frame to generate a predicted image data group. The predicted image data group includes a first sub predicted image data group and a second sub predicted image data group. The compressor compresses the first sub predicted image data group by a using unit of the first sub predicted image data group in the predicted image data group to generate a first compressed image data group, and compresses the second sub predicted image data group by using a unit of the second sub predicted image data group in the predicted image data group to generate a second compressed image data group. The compressor further outputs the first compressed image data group and the second compressed image data group to the buffer. The buffer buffers the first compressed image data group and the second compressed image data group.

According to another aspect of the present invention, a video stream decoding method is provided. The method includes following steps. A video stream is received, and a coded frame in the video stream is decoded to generate a frame. The frame includes a plurality of prediction blocks. An image data group in a prediction block of the frame is predicted to generate a predicted image data group, which includes a first sub predicted image data group and a second sub predicted image data group. The first sub predicted image data group is compressed by using a unit of the first sub predicted image data group in the predicted image data group to generate a first compressed image data group. The second sub predicted image data group is compressed by a using unit of the second sub predicted image data group in the predicted image data group to generate a second compressed image data group. The first compressed image data group and the second compressed image data group are outputted to a buffer.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a conventional video stream decoder;

FIG. 2 is a schematic diagram of a video stream decoding system according to an embodiment of the present invention;

FIG. 3 is a schematic diagram of predicting a prediction block;

FIG. 4 is a schematic diagram of an image data group corresponding to the prediction block in FIG. 3;

FIG. 5 is a schematic diagram of predicting another prediction block;

FIG. 6 is a schematic diagram of an image data group corresponding to the prediction block in FIG. 5;

FIG. 7 is a flowchart of a video stream decoding method 700 according to an embodiment of the present invention;

FIG. 8A is a schematic diagram of a horizontal reference direction;

FIG. 8B is a schematic diagram of a vertical reference direction;

FIG. 8C is a schematic diagram of a two-dimensional reference direction;

FIG. 9 is a schematic diagram of a prediction unit according to an embodiment of the present invention;

FIG. 10 is a flowchart of step S7030 according to an embodiment of the present invention;

FIG. 11A to FIG. 11G are examples of steps in FIG. 10; and

FIG. 12 is a schematic diagram of a reconstruction unit according to an embodiment of the present invention.

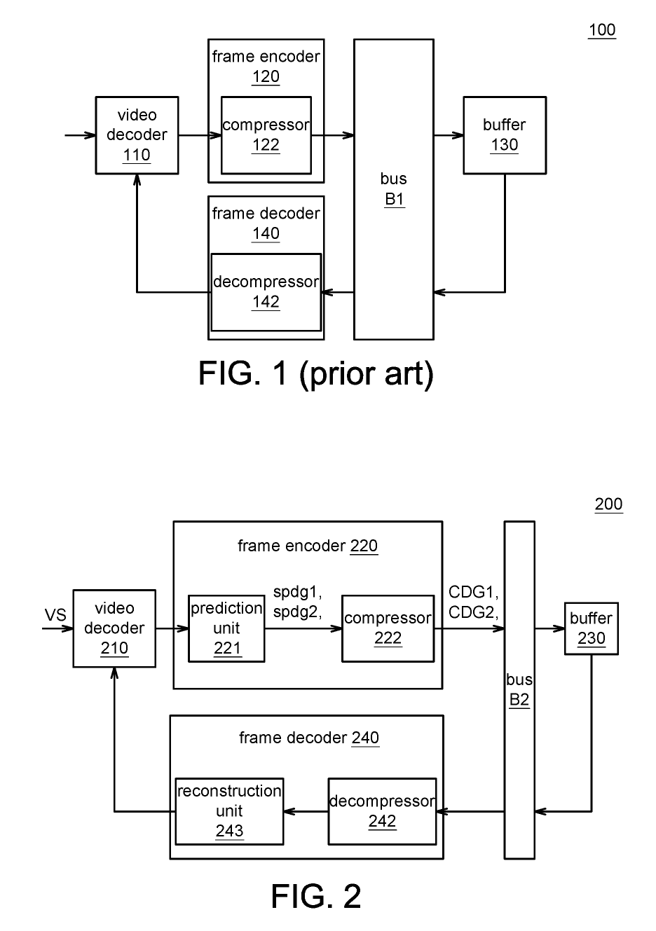

### DETAILED DESCRIPTION OF THE INVENTION

The present invention enhances compression efficiency by a partitioned compression approach to reduce bus bandwidth usage.

FIG. 2 shows a schematic diagram of a video stream decoding system 200 according to an embodiment. The video stream decoding system 200 may be disposed, for example, in a television or a computer, and includes a video decoder 210, a frame encoder 220, a buffer 230 and a frame decoder 240. The frame encoder 220 includes a prediction unit 221 and a compressor 222. The frame decoder 240 includes a decompressor 242 and a reconstruction unit 243. In this embodiment, the video decoder 210, the frame encoder 220, the buffer 230 and the frame decoder 240 are implemented by hardware circuits.

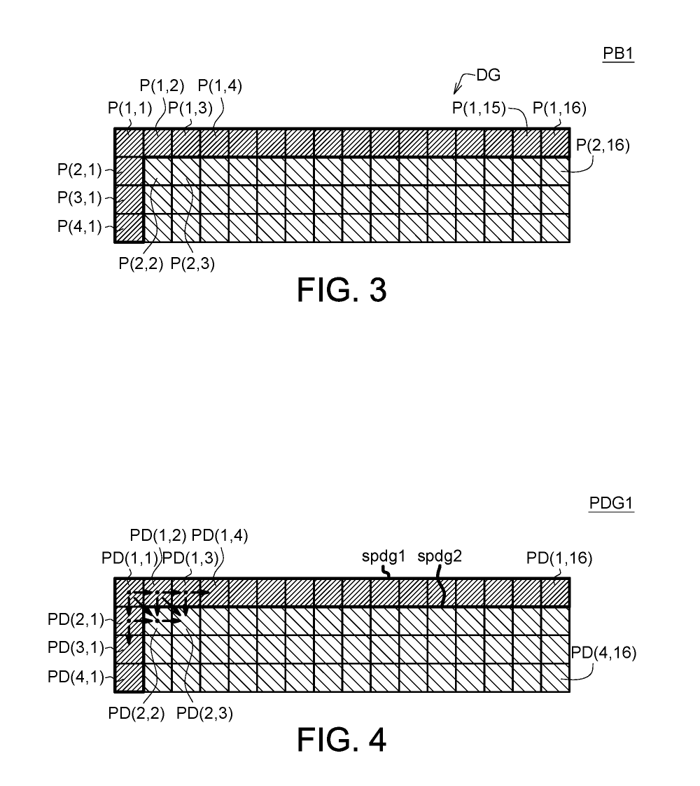

The video decoder 210 receives a video stream VS, which includes a plurality of coded frames. The video decoder 210 decodes a coded frame in the video stream VS to generate a frame. The frame includes a plurality of prediction blocks, each being a smallest unit that can be independently predicted or reconstructed. In one embodiment, a frame includes 1960*1080 pixels, and an image data group DG (shown in FIG. 3) in a prediction block includes 16*4 pixels.

The prediction unit 221 in the frame encoder 220 predicts the frame by a unit of one prediction block, and outputs a plurality of predicted image data groups to the compressor 222 in the frame encoder 220. For example, referring to FIG. 3 showing a diagram of predicting a prediction block PB1, the prediction block PB1 includes 16 columns and 4 rows, and the image data group DG in the prediction block PB1 includes a total of 16*4 pixels. The 1^{st} row includes a pixel P(1, 1), a pixel P(1, 2), . . . and a pixel P(1, 16); the 2^{nd} row includes a pixel P(2, 1), a pixel (2, 2), . . . and a pixel P(2, 16); and so forth.

FIG. 4 shows a schematic diagram of a predicted image data group PDG1 corresponding to the prediction block PB1. In one embodiment, the prediction unit 221 generates the predicted image data group PDG1 by regarding the pixel P(1, 1) as a starting reference pixel, where the arrow represents the reference direction of the pixel. More specifically, the prediction unit 221 generates predicted image data PD(1, 1) corresponding to the pixel (1, 1) according to the pixel P(1, 1) itself, generates predicted image data PD(1, 2) corresponding to the pixel (1, 2) according to a difference between the pixel P(1, 2) and the pixel P(1, 1), generates predicted image data PD(1, 3) corresponding to the pixel (1, 3) according to a difference between the pixel P(1, 3) and the pixel P(1, 2), generates predicted image data PD(1, 4) corresponding to the pixel (1, 4) according to a difference between the pixel P(1, 4) and the pixel P(1, 3), . . . , and generates predicted image data PD(1, 16) corresponding to the pixel P(1, 16) according to a difference between the pixel P(1, 16) and the pixel P(1, 15). In other words, the prediction unit 221 generates the predicted image data PD(1, n) corresponding to the pixel P(1, n) according to the difference between the pixel P(1, n) and the pixel P(1, n−1), where n is an integer between 2 and 16.

Further, the prediction unit 221 generates predicted image data PD(2, 1) corresponding to the pixel (2, 1) according to a difference between the pixel P(2, 1) and the pixel P(1, 1), generates predicted image data PD(3, 1) corresponding to the pixel P(3, 1) according to a difference between the pixel P(3, 1) and the pixel P(2, 1), and generates predicted image data PD(4, 1) corresponding to the pixel P(4, 1) according to a difference between the pixel P(4, 1) and the pixel P(3, 1). In other words, the prediction unit 221 generates the predicted image data PD(m, 1) corresponding to the pixel P(m, 1) according to the difference between the pixel P(m, 1) and the pixel P(m−1, 1), where m is an integer between 2 and 4.

Further, the prediction unit 221 generates predicted image data PD(2, 2) corresponding to the pixel P(2, 2) according to respective differences between the pixel P(2, 2) and the pixels P(1, 1), P(1, 2) and P(2, 1), generates predicted image data PD(2, 3) corresponding to the pixel P(2, 3) according to respective differences between the pixel P(2, 3) and the pixels P(1, 2), P(1, 3) and P(2, 2), and so forth. In other words, the prediction unit 221 generates the predicted image data PD(p, q) corresponding to the pixel P(p, q) according to respective differences between the pixel P(p, q) and the pixels P(p−1, q−1), P(p−1, q) and P(p, q−1), where p is an integer between 2 and 16, and q is an integer between 2 and 4.

The predicted image data group PDG1 includes a first sub predicted image data group spdg1 and a second sub predicted image data group spdg2. The first sub predicted image data group spdg1 includes the predicted image data corresponding to the starting reference pixel, e.g., the predicted image data PD(1, 1) and the predicted image data of which a reference pixel number is equal to 1 (i.e., with only one reference pixel), e.g., the predicted image data PD(1, 2), PD(1, 3), . . . , PD(1, 16), and the predicted image data PD(2, 1), PD(3, 1) and PD (4, 1). The second sub predicted image data group spdg2 includes predicted image data of which a reference pixel number is greater than 1 (i.e., with more than one reference pixel), e.g., the predicted image data PD(2, 2), PD (2, 3), . . . , PD(4, 16).

The compressor 222 in the frame encoder 220 compresses the first sub predicted image data group spdg1 by using a unit of the first sub predicted image data group spdg1 to generate a first compressed image data group CDG1, and outputs the first compressed image data group CDG1 to the buffer 230 through a bus B2. Further, the compressor 222 in the frame encoder 220 compresses the second sub predicted image data group spdg2 by using a unit of the second sub predicted image data group spdg2 to generate a second compressed image data group CDG2, and outputs the second compressed image data group CDG2 to the buffer 230 through a bus B2.

When the video decoder 210 needs to refer to the compressed image data group during the decoding process, the frame decoder 240 receives the first compressed image data group CDG1 and the second compressed image data group CDG2 from the buffer 230 through the bus B2.

The decompressor 242 in the frame decoder 240 decompresses the first compressed image data group CDG1 to generate the first sub predicted image data group spdg1, and further compresses the second compressed image data group CDG2 to generate the second sub predicted image data group spdg2.

The reconstruction unit 243 in the frame decoder 240 performs reconstruction according to the first sub predicted image data group spdg1 and the second sub predicted image data group spdg2 to generate the image data group DG in the prediction block PB1 of the frame.

The video decoder 210 receives the image data group DG in the prediction block PB1 of the frame, and decodes another coded frame in the video stream VS with reference to the image data group DG.

In one embodiment, the compressor 222 in the frame encoder 220 is a fixed length encoder, and the decompressor 242 in the frame decoder 240 is a fixed length decoder. According to analysis, the variance in the pixel values of the first sub predicted image data group spdg1 and the variance in the pixel values of the second sub predicted image data group spdg2 are different. Thus, compared to a fixed length encoder that compresses the predicted image data group PDG1 by using a unit of the predicted image data group PDG1, the compression efficiencies of a fixed length encoder that respectively compresses the first sub predicted image data group spdg1 and the second sub predicted image data group spdg2 by respectively using a unit of the first sub predicted image data group spdg1 and the second sub predicted image data group spdg2 are different. For example, in one embodiment, a fixed length encoder compresses the predicted image data group PDG1 by using a unit of the predicted image data group PDG1, and each set of predicted image data is compressed into a set of compressed image data of a certain bit count (e.g., 6 bits). In this embodiment, the fixed length encoder respectively compresses the first sub predicted image data group spdg1 and the second sub predicted image data group spdg2 by respectively using a unit of the first sub predicted image data group spdg1 and the second sub predicted image data group spdg2, and at least one of the first sub predicted image data group spdg1 and the second sub predicted image data group spdg2 can be compressed into a set of compressed image data of a lower bit count (e.g., 5 bits). It is known from the above that, through a partitioned compression approach, the data amount of a compressed image data group can be reduced to further reduce the bus bandwidth usage of the bus B2.

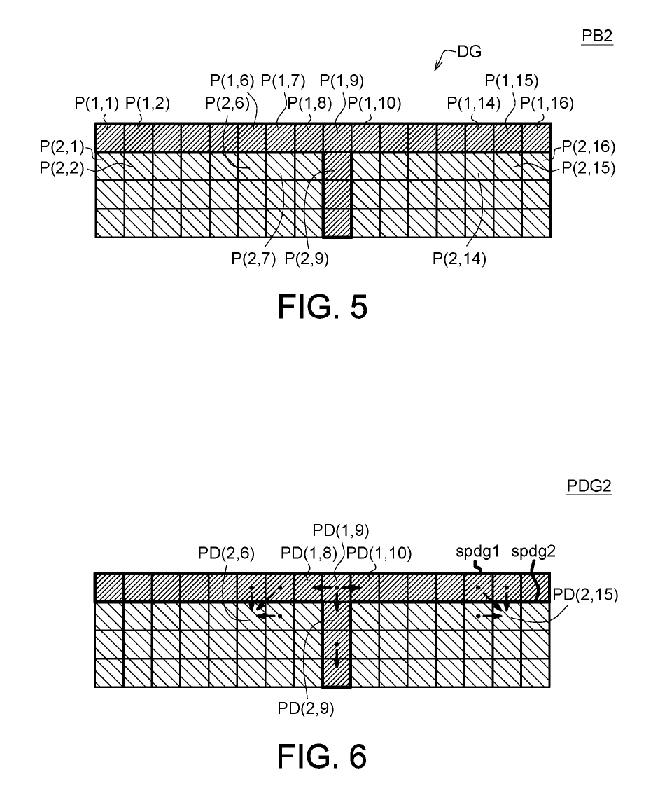

It should be noted that, the present invention is not limited to the partitioning method applied to the predicted image data group as shown in FIG. 4. In practice, the partitioning method for a predicted image data group is associated with the position of a starting reference pixel. FIG. 5 shows a schematic diagram of predicting a prediction block PB2. Referring to FIG. 5, the prediction block PB2 includes 16 columns and 4 rows, and the image data group DG in the prediction block PB2 includes a total of 16*4 pixels. The 1^{st} row includes pixels P(1, 1), P(1, 2), . . . and P(1, 16); the 2^{nd} row includes pixels P(2, 1), (2, 2), . . . and P(2, 16); and so forth. FIG. 6 shows a schematic diagram of a predicted image data group PDG2 corresponding to the prediction block PB2. In one embodiment, the prediction unit 221 generates the predicted image data group PDG2 by regarding the pixel P(1, 9) as a starting reference pixel, where the arrow represents the reference direction of the pixel. More specifically, the prediction unit 221 generates predicted image data PD(1, 9) corresponding to the pixel (1, 9) according to the pixel P(1, 9) itself, generates predicted image data PD(1, 10) corresponding to the pixel (1, 10) according to a difference between the pixel P(1, 10) and the pixel P(1, 9), generates predicted image data PD(1, 8) corresponding to the pixel (1, 8) according to a difference between the pixel P(1, 8) and the pixel P(1, 9), generates predicted image data PD(2, 9) corresponding to the pixel (2, 9) according to a difference between the pixel P(2, 9) and the pixel P(1, 9), and so forth. Further, the prediction unit 221 generates predicted image data PD(2, 6) corresponding to the pixel P(2, 6) according to respective differences between the pixel P(2, 6) and the pixels (1, 6), P(1, 7) and P(2, 7), generates predicted image data PD(2, 15) corresponding to the pixel P(2, 15) according to respective differences between the pixel (2, 15) and the pixels P(1, 14), P(1, 15) and P(2, 14), and so forth.

The predicted image data group PDG2 includes a first sub predicted image data group spdg1 and a second sub predicted image data group spdg2. The first sub predicted image data group spdg1 includes predicted image data corresponding to the starting reference pixel, e.g., the predicted image data PD(1, 9) and the predicted image data of which a reference pixel number is equal to 1 (i.e., with only one reference pixel), e.g., the predicted image data PD(1, 10), PD(1, 8), and PD(2, 9). The second sub predicted image data group spdg2 includes predicted image data with reference pixel of which a reference pixel number is greater than 1 (i.e., with more than one reference pixel), e.g., the predicted image data PD(2, 6) and PD(2, 15).

Next, the compressor 222 in the frame encoder 220 compresses the first sub predicted image data group spdg1 by using a unit of the first sub predicted image data group spdg1 to generate a first compressed image data group CDG1, and outputs the first compressed image data group CDG1 to the buffer 230 through the bus B2. Further, the compressor 222 in the frame encoder 220 compresses the second sub predicted image data group spdg2 by using a unit of the second sub predicted image data group spdg2 to generate a second compressed image data group CDG2, and outputs the second compressed image data group CDG2 to the buffer 230 through the bus B2.

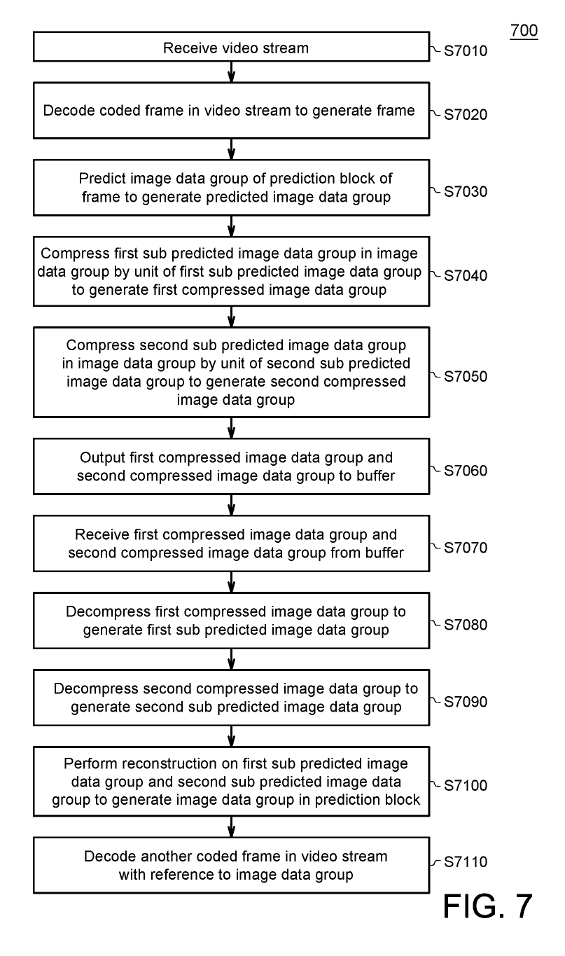

FIG. 7 shows a flowchart of a video stream decoding method 700 according to an embodiment of the present invention. Referring to FIG. 7, the video stream decoding method 700 includes following steps.

In step S7010, a video stream is received.

In step S7020, a coded frame in the video stream is decoded to generate a frame.

In step S7030, an image data group in a prediction block of the frame is predicted to generate a predicted image data group.

In step S7040, by using a unit a first sub predicted image data group in the predicted image data group, the first sub predicted image data group is compressed to generate a first compressed image data group.

In step S7050, by using a unit a second sub predicted image data group in the predicted image data group, the second sub predicted image data group is compressed to generate a second compressed image data group.

In step S7060, the first compressed image data group and the second compressed image data group are outputted to the buffer.

In step S7070, the first compressed image data group and the second compressed image data group are received from the buffer.

In step S7080, the first compressed image data group is decompressed to generate the first sub predicted image data group.

In step S7090, the second compressed image data group is decompressed to generate the second sub predicted image data group.

In step S7100, reconstruction is performed according to the first sub predicted image data group and the second sub predicted image data group to generate the image data group in the prediction block.

In step S7110, another coded frame in the video data stream is decoded with reference to the image data group.

The video stream decoding method 700 may be performed by the video stream decoding system 200. Steps S7010, S7020, and S7110 may be performed by the video decoder 210, step S7030 may be performed by the prediction unit 221 in the frame encoder 220, steps S7040, S7050 and S7060 may be performed by the compressor 222 in the frame encoder 220, steps S7070, S7080 and S7090 may be performed by the decompressor 242 in the frame decoder 240, and step S7100 may be performed by the reconstruction unit 243 in the frame decoder 240. With the description on the video stream decoding system 200 of the application, one person skilled in the art should understand details of performing the video stream decoding method using the video stream decoding system 200, and such related description shall be omitted herein.

It should be noted that, in the above embodiments, for example but not limited to, the video decoder 210, the frame encoder 220 and the frame decoder 240 are implemented by hardware circuits. In other words, the video decoder 210, the frame encoder 220 and the frame decoder 240 may also be implemented by a processor in conjunction with software programs.

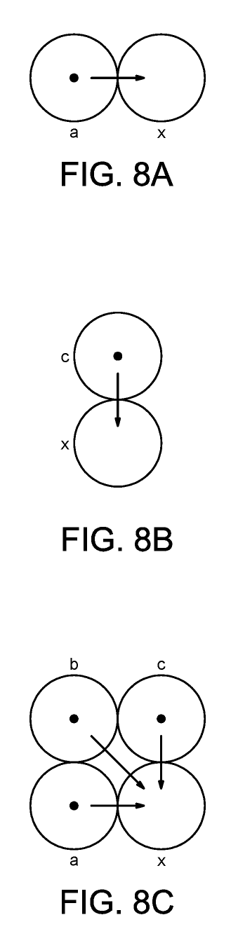

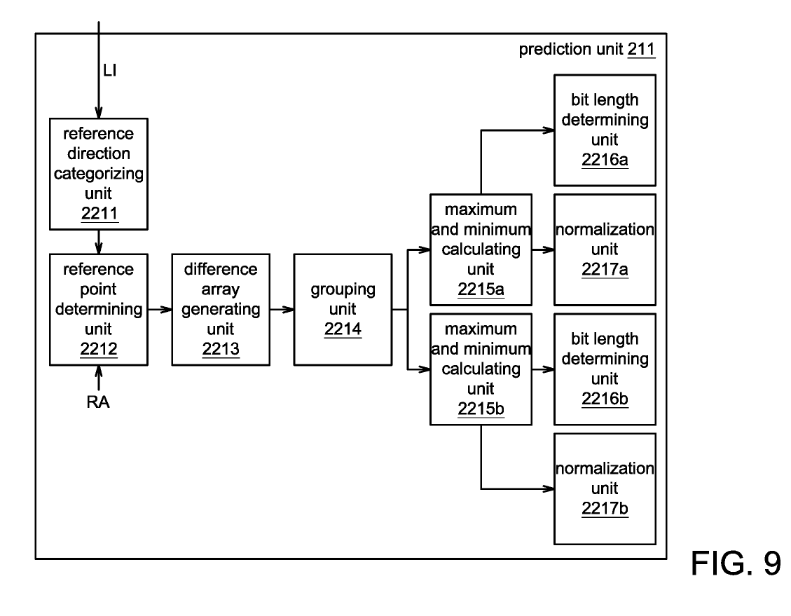

Please refer to FIG. 8A to FIG. 8C. FIG. 8A shows a schematic diagram of a horizontal reference direction, FIG. 8B shows a schematic diagram of a vertical reference direction and FIG. 8C shows a schematic diagram of a two-dimensional reference direction. The horizontal reference direction, the vertical reference direction and the two-dimensional reference direction adopt a reference algorithm RA (shown in FIG. 9) to analyze a reference point. As shown in FIG. 8A, in one embodiment, for the 1^{st}-row pixels (except the 1^{St}-row-1^{st}-column pixel) in a prediction block, the horizontal reference direction may be adopted to obtain that the pixel a is a reference point of the pixel x though the reference algorithm RA. As shown in FIG. 8B, in one embodiment, for the 1^{st}-column pixels (except the 1^{st}-row-1^{st} column pixel) in a prediction block, the vertical reference direction may be adopted to obtain that the pixel c is the reference point of the pixel x through the reference algorithm RA. As shown in FIG. 8C, in one embodiment, for non-1^{st}-row and non-1^{st}-column pixels in a prediction block, the two-dimensional reference direction may be adopted to obtain which of the pixels a, b and c is the reference point of the pixels x through the reference algorithm RA. In one embodiment, the reference algorithm RA for two-dimensional reference direction can be represented as shown in the following:

```
if (abs(b−a)<abs(b−c)) {
  if (abs(b−((a+c)/2))<abs(a−b))
Reference point is b
  else
    Reference point is c
}else{
  if (abs(b−((a+c)/2))<abs(b−c))
    Reference point is b
  else
    Reference point is a
}
```

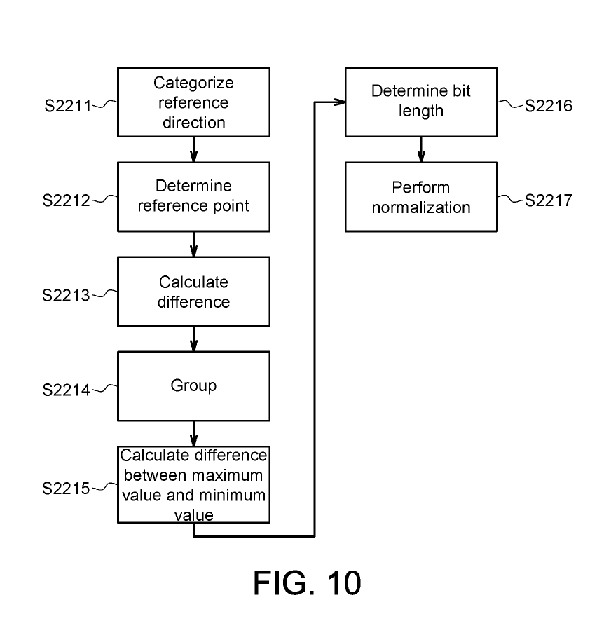

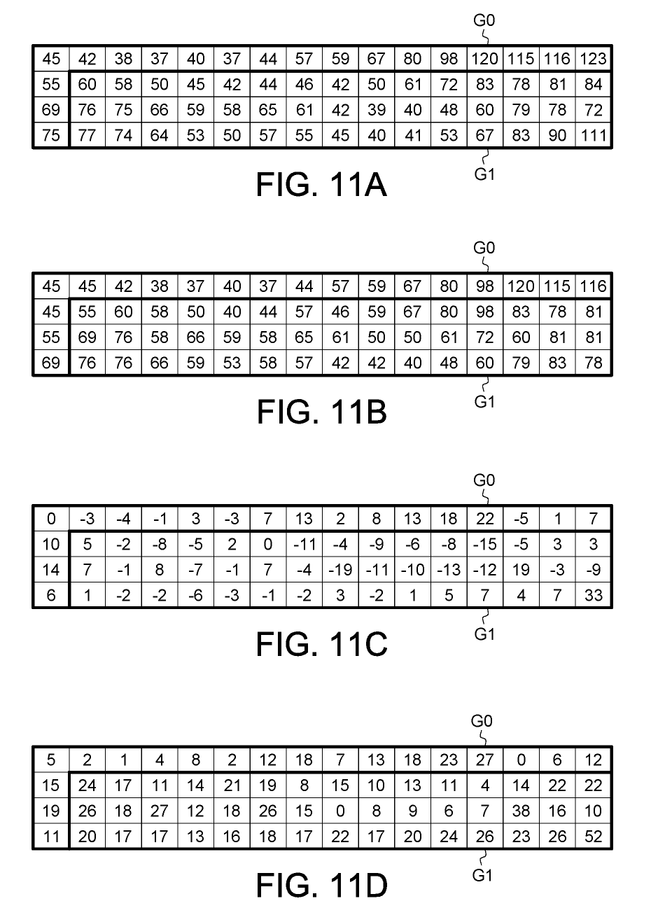

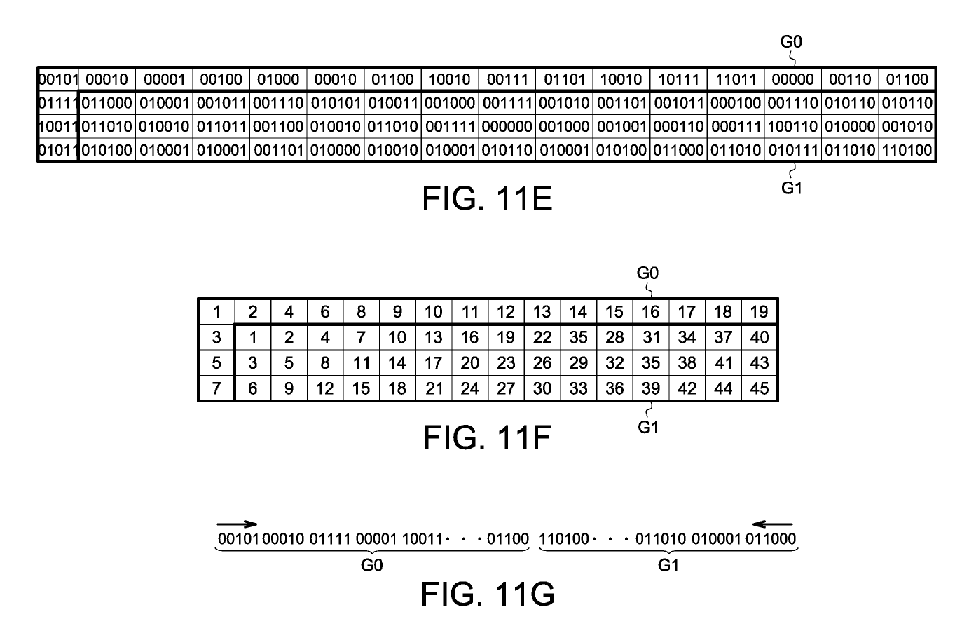

Please refer to FIG. 9 to FIG. 11G. FIG. 9 shows a schematic diagram of a prediction unit 221 according to an embodiment. FIG. 10 shows a flowchart of step S7030 performed on a pixel according to an embodiment. FIG. 11A to FIG. 11G are used to illustrate the steps in FIG. 10. The prediction unit 221 includes a reference direction categorizing unit 2211, a reference point determining unit 2212, a difference array generating unit 2213, a grouping unit 2214, maximum and minimum calculating units 2215a and 2215b, bit length determining unit 2216a and 2216b, and normalization units 2217a and 2217b.

FIG. 11A shows pixel values of one prediction block. In step S2211, the reference direction categorizing unit 2211 categorizes all of the pixels into four reference directions according to position information L1. The first reference direction is “no reference direction”, e.g., the starting reference pixel at the 1^{st} row and 1^{st} column. The second reference direction is the “horizontal reference direction”, e.g., the 1^{st}-row pixels (except the starting reference pixel at the 1^{st} row and 1^{st} column). The third reference direction is the “vertical reference direction”, e.g., the 1^{st}-column pixels (except the starting reference pixel at the 1^{st} row and 1^{st} column). The fourth reference direction is the “two-dimensional reference direction”, e.g., pixels except those at the 1^{st} row or 1^{st} column. Further, all of the pixels are group into a group G0 and a group G1 according to the reference directions. The group G0 includes pixels of “no reference direction”, “horizontal reference direction” and “vertical reference direction”, and the group G1 includes pixels of “two-dimensional reference direction”.

In step S2212, the reference point determining unit 2212 determines the reference point of each pixel according to the reference directions that the reference direction categorizing unit 2211 provides and the reference algorithm RA corresponding to FIG. 8A to FIG. 8C. FIG. 11B shows the pixel value of reference point for each pixel. For example, the starting reference pixel at the 1^{st}-row-1^{st}-column does not have a reference direction, and so the pixel value of the reference point at the 1^{st}-row-1^{st}-column is itself and is 45; the reference point of the 1^{st}-row-2^{nd}-column pixel is the pixel at its left side, and has a pixel value of 45; the reference point of the 2^{nd}-row-1^{st}-column pixel is the pixel above it, and has a pixel value of 45; the reference point of the 2^{nd}-row-2^{nd}-column pixel is the pixel at its left, and has a pixel value of 55.

In step S2213, the difference array generating unit 2213 calculates a corresponding difference of FIG. 11A and FIG. 11B (as shown in FIG. 11C) according to the reference point information that the reference point determining unit 2212 provides. For example, the difference between the 1^{st}-row-1^{st}-column pixel and its reference point is “0” (i.e., 45-45), the difference between the 1^{st}-row-2^{nd}-column pixel and its reference point is “−3” (i.e., 42−45), the difference between the 2^{nd}-row-1^{st}-column pixel and its reference point is “10” (i.e., 55−45), and the difference between the 2^{nd}-row-2^{nd}-column pixel and its reference point is “5” (i.e., 60−55).

In step S2214, the grouping unit 2214 transmits all of the differences corresponding to the group G0 to the maximum and minimum calculating unit 2215a, and the grouping unit 2214 transmits all of the differences corresponding to the group G1 to the maximum and minimum calculating unit 2215b.

In step S2215, the maximum and minimum calculating unit 2215a calculates a maximum value and a minimum value among the differences of the group G0, and the maximum and minimum calculating unit 2215b calculates a maximum value and a minimum value among the differences of the group G1. For example, the maximum value among all of the differences of the group G0 is “22”, and the minimum value among all of the differences of the group G0 is “−5”; the maximum value among all of the differences of the group G1 is “33”, and the minimum value among all of the differences of the group G1 is “−19”.

In step S2216, the bit length determining unit 2216a determines a bit length according to the maximum value and the minimum value among all of the differences of the group G0, and the bit length determining unit 2216b determines a bit length according to the maximum value and the minimum value among all of the differences of the group G1. For example, the maximum value and the minimum value among all of the differences of the group G0 differ by 27, and so the bit length determining unit 2216a determines that the bit length corresponding to the group G0 to be 5, and outputs the bit length corresponding to the group G0 to the compressor 222. The bit length of 5 means that the compressor 222 utilizes 5 bits to compress the group G0. The maximum value and the minimum value among all of the differences of the group G1 differ by 52, and the bit length determining unit 2216b determines that the bit length corresponding to the group G1 to be 6, and outputs the bit length corresponding to the group G1 to the compressor 222. The bit length of 6 means that the compressor 222 utilizes 6 bits to compress the group G1.

In step S2217, the normalization unit 2217a and 2217b normalize the groups G0 and G1, respectively. For example, the normalization unit 2217a subtracts each of the differences of the group G0 in FIG. 11C by the minimum value among all of the differences of the group G0 (e.g., −5), and the normalization unit 2217b subtracts each of the differences of the group G1 in FIG. 11C by the minimum value among all of the differences of the group G1 (e.g., −19), hence obtaining the predicted image data in FIG. 11D.

In step S7040 and step S7050, the compressor 222 performs compression according to the bit lengths respectively corresponding to the groups G0 and G1. For example, as shown in FIG. 11D, the predicted image data corresponding to the group G0 is coded into 5-bit compressed image data (e.g., the binary data shown in FIG. 11E) by the compressor 222, and the predicted image data corresponding to the group G1 is coded into 6-bit compressed image data (e.g., the binary data shown in FIG. 11E) by the compressor 222.

In step S7060, as shown in FIG. 11G, according to the storage sequence information in FIG. 11F, the compressor 222 stores the compressed image data corresponding to the group G0 in a front-to-back sequence into the buffer 230, and stores the compressed image data corresponding the group G1 in a back-to-front sequence into the buffer 230 (step S7060).

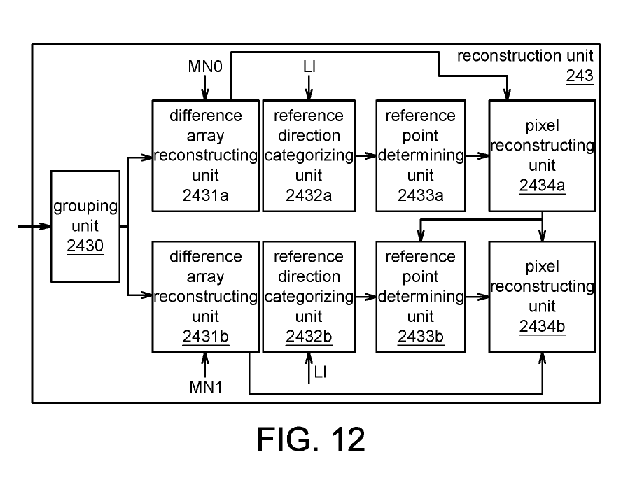

FIG. 12 shows a schematic diagram of the reconstruction unit 243 according to an embodiment of the present invention. The reconstruction unit 243 includes a grouping unit 2430, difference array reconstructing units 2431a and 2431b, reference direction categorizing units 2432a and 2432b, reference point determining units 2433a and 2433b, and pixel reconstructing units 2434a and 2434b.

The decompressor 242 obtains the binary data shown in FIG. 11G from the buffer 230, and generates the compressed image data shown in FIG. 11E according to the storage sequence shown in FIG. 11F. The decompressor 242 decompresses the compressed image data shown in FIG. 11E to generate the predicted image data shown in FIG. 11D.

The grouping unit 2430 obtains the predicted image data shown in FIG. 11D from the decompressor 242, transmits the predicted image data corresponding to the group G0 to the difference array reconstructing unit 2431a, and transmits the predicted image data corresponding to the group G1 to the difference array reconstructing unit 2431b for a reconstruction process.

The difference array reconstructing unit 2431a restores the differences corresponding to the group G0 in FIG. 11C according to the minimum value MN0 among all of the differences corresponding to the group G0, and restores the differences corresponding to the group G1 in FIG. 11C according to the minimum value MN1 among all of the differences corresponding to the group G1.

The reference direction categorizing units 2432a and 2432b categorize all of the pixels into four reference directions according to position information L1. The first reference direction is “no reference direction”, e.g., the starting reference pixel at the 1^{st} row and 1^{st} column in FIG. 11A. The second reference direction is the “horizontal reference direction”, e.g., the 1^{st}-row pixels in FIG. 11A (except the starting reference pixel at the 1^{st} row and 1^{st} column). The third reference direction is the “vertical reference direction”, e.g., the 1^{st}-column pixels in FIG. 11A (except the starting reference pixel at the 1^{st} row and 1^{st} column). The fourth reference direction is the “two-dimensional reference direction”, e.g., pixels except those at the 1^{st} row or 1^{st} column in FIG. 11A.

Details of how the pixel reconstructing units 2434a and 2434b restore the original data in FIG. 11A according to FIG. 11C are given below.

The original data of the 1^{st}-row-1^{st}-column pixel (e.g., 45) is directly obtained from the buffer 230 by the pixel reconstructing unit 2434a.

The 1^{st}-row-2^{nd}-column pixel corresponds to the horizontal reference direction, and so the reference point of the 1^{st}-row-2^{nd}-column pixel is the 1^{st}-row-1^{st}-column pixel. The pixel reconstructing unit 2434a may calculate the 1^{st}-row-2^{nd}-column pixel value according to the reference point and the difference (e.g., 45+(−3)=42).

The 1^{st}-row-3^{rd}-column pixel corresponds to the horizontal reference direction, and so the reference point of the 1^{st}-row-3^{rd}-column pixel is the 1^{st}-row-2^{nd}-column pixel. The pixel reconstructing unit 2434a may calculate the 1^{st}-row-3^{rd}-column pixel value according to the reference point and the difference (e.g., 42+(−4)=38).

Accordingly, all of the 1^{st}-row pixels may be calculated according to the above method.

The 2^{nd}-row-1^{st}-column pixel corresponds to the vertical reference direction, and so the reference point of the 2^{nd}-row-1^{st}-column pixel is the 1^{st}-row-1^{st}-column pixel. The pixel reconstructing unit 2434a may calculate the 2^{nd}-row-1^{st}-row pixel value according to the reference point and the difference (e.g., 45+(+10)=55).

The 3^{rd}-row-1^{st}-column pixel corresponds to the vertical reference direction, and so the reference point of the 3^{rd}-row-1^{st}-column pixel is the 2^{nd}-row-1^{st}-column pixel. The pixel reconstructing unit 2434a may calculate the 3^{rd}-row-1^{st}-row pixel value according to the reference point and the difference (e.g., 55+(+14)=69).

Accordingly, all of the 1^{st}-column pixels may be calculated according to the above method.

The 2^{nd}-row-2^{nd}-column pixel corresponds to the two-dimensional reference direction, and so the reference point determining unit 2433b may determine that the reference point of the 2^{nd}-row-2^{nd}-column pixel is the pixel at its left side according to the 1^{st}-row-1^{st}-column, 1^{st}-row-2^{nd}-column and 2^{nd}-row-1^{st}-column pixel values. The pixel reconstructing unit 2434b may calculate the 2^{nd}-row-2^{nd}-column pixel value according to the reference point and the difference (e.g., 55+(+5)=60).

The 2^{nd}-row-3^{rd}-column pixel corresponds to the two-dimensional reference direction, and so the reference point determining unit 2433b may determine that the reference point of the 3^{rd}-row-2^{nd}-column pixel is the pixel at its left side according to the 1^{st}-row-2^{nd}-column, 1^{st}-row-3^{rd}-column and 2^{nd}-row-2^{nd}-column pixel values. The pixel reconstructing unit 2434b may calculate the 2^{nd}-row-3^{rd}-column pixel value according to the reference point and the difference (e.g., 60+(−5)=58).

The 3^{rd}-row-2^{nd}-column pixel corresponds to the two-dimensional reference direction, and so the reference point determining unit 2433b may determine that the reference point of the 3^{rd}-row-2^{nd}-column pixel is the pixel at its left side according to the 2^{nd}-row-1^{st}-column, 2^{nd}-row-2^{nd}-column and 3^{rd}-row-1^{st}-column pixel values. The pixel reconstructing unit 2434b may calculate the 3^{rd}-row-2^{nd}-column pixel value according to the reference point and the difference (e.g., 69+(+7)=76).

Accordingly, all of non-1^{st}-column and non-1^{st}-row pixel values may be calculated according to the above method.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video stream decoding system, comprising:
a video decoder, receiving a video stream, decoding a coded frame in the video stream to generate a frame, the frame comprising a plurality of prediction blocks;
a frame encoder, comprising:
a prediction unit, predicting an image data group in one prediction block of the frame to generate a predicted image data group, the predicted image data group comprising a first sub predicted image data group and a second sub predicted image data group; and
a compressor, compressing the first sub predicted image data group by using a unit of the first sub predicted image data group in the predicted image data group to generate a first compressed image data group, compressing the second sub predicted image data group by using a unit of the second sub predicted image data group in the predicted image data group to generate a second compressed image data group, and outputting the first compressed image data group and the second compressed image data group to a buffer; and
the buffer, buffering the first compressed image data group and the second compressed image data group.

2. The video stream decoding system according to claim 1, wherein the first sub predicted image data group comprises, in the predicted image data group, predicted image data corresponding to a starting reference pixel.

3. The video stream decoding system according to claim 1, wherein the first sub predicted image data group comprises, in the predicted image data group, all predicted image data of which a reference pixel number is equal to 1.

4. The video stream decoding system according to claim 1, wherein the second sub predicted image data group comprises, in the predicted image data group, all predicted image data of which a reference pixel number is greater than 1.

5. The video stream decoding system according to claim 1, wherein the compressor is a fixed length encoder.

6. The video stream decoding system according to claim 1, further comprising:
a frame decoder, comprising:
a decompressor, receiving the first compressed image data group and the second compressed image data group from the buffer, decompressing the first compressed image data group to generate the first sub predicted image data group, and decompressing the second compressed image data group to generate the second sub predicted image data group; and
a reconstruction unit, performing reconstruction according to the first sub predicted image data group and the second sub predicted image data group to generate the image data group in the prediction block;
wherein, the video decoder receives the image data group in the prediction block from the reconstruction unit, and decodes another coded frame in the video stream with reference to the image data group.

7. A video stream decoding method, comprising:
receiving a video stream;
decoding a coded frame in the video stream to generate a frame, the frame comprising a plurality of prediction blocks;
predicting an image data group in a prediction block of the frame to generate a predicted image data group, the predicted image data group comprising a first sub predicted image data group and a second sub predicted image data group;
compressing the first sub predicted image data group by using a unit of the first sub predicted image data group in the predicted image data group to generate a first compressed image data group;
compressing the second sub predicted image data group by using a unit of the second sub predicted image data group in the predicted image data group to generate a second compressed image data group; and
outputting the first compressed image data group and the second compressed image data group to a buffer.

8. The video stream decoding method according to claim 7, wherein the first sub predicted image data group comprises, in the predicted image data group, predicted image data corresponding to a starting reference pixel.

9. The video stream decoding method according to claim 7, wherein the first sub predicted image data group comprises, in the predicted image data group, all predicted image data of which a reference pixel number is equal to 1.

10. The video stream decoding method according to claim 7, wherein the second sub predicted image data group, in the predicted image data group, all predicted image data of which a reference pixel number is greater than 1.

11. The video stream decoding method according to claim 7, wherein:
the step of compressing the first sub predicted image data group comprises compressing the first sub predicted image data group by a fixed length coding method; and
the step of compressing the second sub predicted image data group comprises compressing the second sub predicted image data group by the fixed length coding method.

12. The video stream decoding method according to claim 7, further comprising:
receiving the first compressed image data group and the second compressed image data group from the buffer;
decompressing the first compressed image data group to generate the first sub predicted image data group;
decompressing the second compressed image data group to generate the second sub predicted image data group;
performing reconstruction according to the first sub predicted image data group and the second sub predicted image data group to generate the image data group in the prediction block;
decoding another frame in the video stream with reference to the image data group.
